(19) United States
(12) Patent Application Publication
(10) Pub. No.: US 2012/0259743 A1
(43) Pub. Date: Oct. 11, 2012

(54) SYSTEM AND METHOD FOR ROOM DESIGN VISUALIZATION

(75) Inventor: Raymond L. Pate, JR., Adrian, MI (US)

(73) Assignee: MASCO CABINETRY GROUP LLC, Taylor, MI (US)

(21) Appl. No.: 13/083,851

(22) Filed: Apr. 11, 2011

(51) Int. Cl. G06Q 30/00

(52) U.S. Cl. 705/27.2

(57) ABSTRACT

The disclosed system and method provide the user with the capability of selecting from among various particular products utilized in the design of an interior space, such as a kitchen, reviewing product specifications, design and finish combinations, and visualizing the products, both in isolation and placed in a photorealistic depiction of the selected products in one of a selected number of different room layouts. The system provides the user with the option of creating a unique account, including contact information, and information relating to one or more product selections preferred by the customer, which may then be electronically transmitted by the customer to a selected location remote from the system. The system and method may also provide the capability for a limited group, such as product manufacturer and/or dealer personnel, to access one or more of the customers' unique accounts to obtain contact information and/or product preferences for the customers.

### TECHNICAL FIELD

This invention relates to systems and methods for providing a computer-assisted visualization of an interior room design.

### SUMMARY

The disclosed system and method provide the user with the capability of selecting from among various particular products utilized in the design of an interior space, such as a kitchen, reviewing product specifications, design and finish combinations, and visualizing the products, both in isolation and placed in a photorealistic depiction of the selected products in one of a selected number of different room layouts.

In the disclosed system and method, the user is able to switch from between graphic display windows depicting various brands, product series, and product types to review brand messages, product specifications, and isolated product depictions. The disclosed system and method similarly allows the user to quickly select from among a variety of product, and colors, materials, and textures, and view products having the specific selected characteristics, both in isolation, and placed in a three-dimensional photorealistic depiction of a selected room.

The disclosed system and method provides the user with the option of creating a unique account, including unique customer contact information, and memory adequate to store one or more product selections preferred by the customer. The disclosed system and method may also provide the capability for the customer to transmit the customer's currently stored product selections, and/or particular room visualizations including selected product sets, such as by electronic mail, from a system kiosk (or other system user interface) to another personal computer, other personal data device, or other virtual data location managed by the customer.

The disclosed system and method may also provide the capability for the system administrator to periodically access one or more of the customer's unique accounts to obtain contact information for the potential customers, and to obtain the customer's product selection data.

In the disclosed application for kitchens, a customer and/or designer may quickly switch between displays of various preselected product lines of cabinets, flooring, countertops, appliances, and wall treatments, and, at any time, obtain a photorealistic rendering of the currently selected products/features superimposed in a selected one of a number of predefined kitchen layouts. By activating selection “buttons” on a touch-sensitive display, the user may quickly access product depiction and information screens, select a new design, color, or texture for a particular product, and return to a re-rendering of the selected kitchen layout, now depicting the newly selected product design features in a photorealistic three-dimensional perspective view of the kitchen.

### BRIEF DESCRIPTION OF THE DRAWINGS

FIG. 1 is a representational view of a user station which may be used to implement the disclosed system and method;

FIG. 2 is a representational view of a single-user computer system which may be used to implement the disclosed system and method;

FIG. 3 is a representational view of another computer system which may be used to implement the disclosed system and method;

FIG. 4 is a flow diagram illustrating an exemplary use of interactive screens employed by the disclosed system and method for viewing and selecting brands, product series, individual products, designs, and accessories, and for visualizing the user's selections in a photorealistic rendering of a selected room layout;

FIG. 5 is a representation of the opening “brand” screen utilized in a disclosed embodiment of the system and method;

FIG. 6 is a representation of a “product series” screen utilized in a disclosed embodiment of the system and method;

FIG. 7 is a representation of an “explore” screen utilized in a disclosed embodiment of the system and method;

FIG. 8 is a representation of a “browse and visualize” screen utilized in a disclosed embodiment of the system and method;

FIG. 9 is a representation of a cabinet door “browse” screen utilized in a disclosed embodiment of the system and method;

FIG. 10 is a representation of a countertop “browse” screen utilized in a disclosed embodiment of the system and method;

FIG. 11 is a representation of a “room choice” screen utilized in a disclosed embodiment of the system and method;

FIG. 12 is a representation of a “visualize room” screen utilized in a disclosed embodiment of the system and method;

FIG. 13 is a representation of a “mood board” utilized in a disclosed embodiment of the system and method;

FIG. 14 is a representation of a “product features” screen utilized in a disclosed embodiment of the system and method;

FIG. 15 is a representation of an “accessories/enhancements” screen utilized in a disclosed embodiment of the system and method;

FIG. 16 is a representation of another “product features” screen utilized in a disclosed embodiment of the system and method; and

FIG. 17 is a representation of a “customer account sign-in” screen utilized in a disclosed embodiment of the system and method.

### DETAILED DESCRIPTION

As required, detailed embodiments of the present invention are disclosed herein; however, it is to be understood that the disclosed embodiments are merely exemplary of the invention that may be embodied in various and alternative forms. The figures are not presented in color, nor are they necessarily to scale. Some features may be exaggerated or minimized to show details of particular components. Therefore, specific structural and functional details disclosed herein are not to be interpreted as limiting, but merely as a representative basis for teaching one skilled in the art to variously employ the present invention.

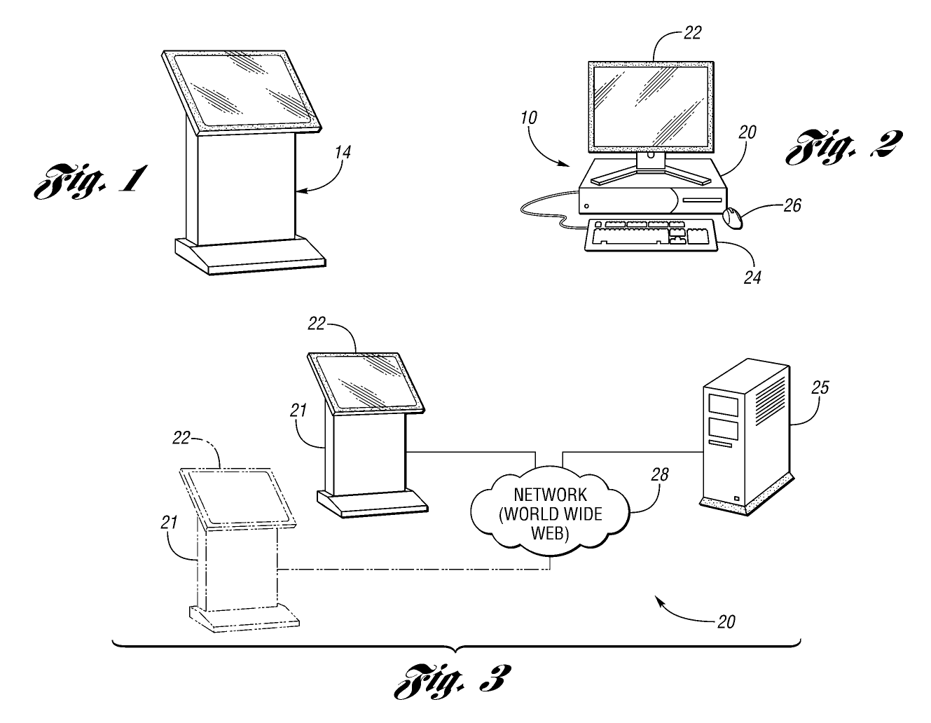

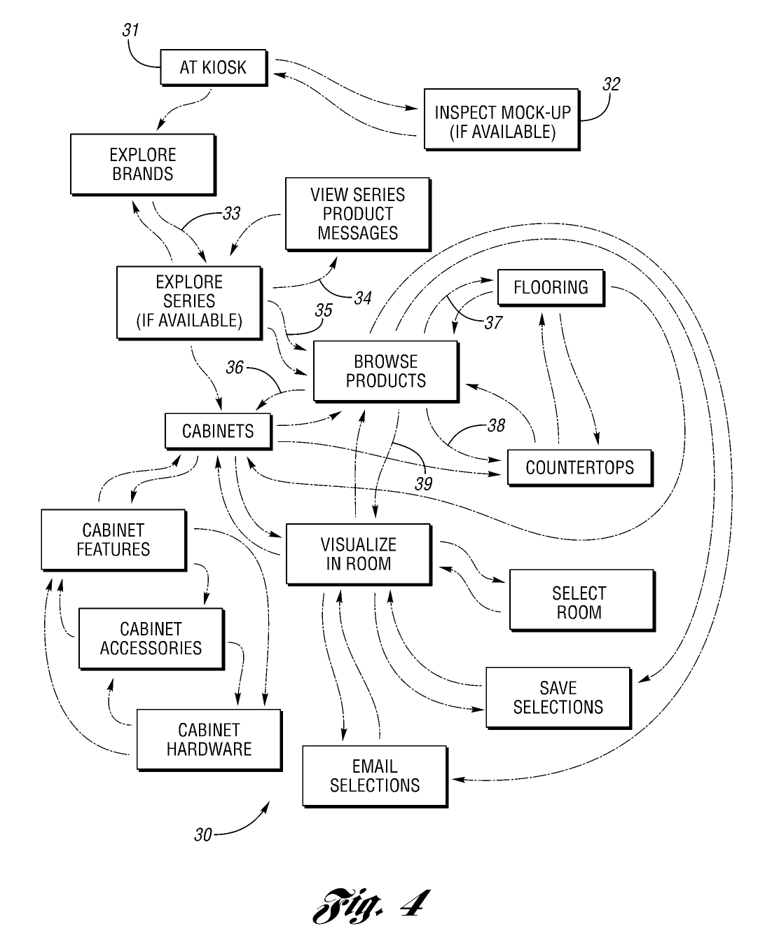

Referring to FIGS. 1 and 2, the disclosed system 10 typically includes one or more computer systems 20 connected to at least one user interface 22, 14. In one embodiment, the user interface is a kiosk 14 including a relatively large, high-resolution flat-panel display. In the embodiment illustrated in FIG. 1, the kiosk display includes a touch sensitive screen, thereby allowing the user to navigate between screen representations to initiate product review, selection, and room visualizations quickly, and in a sequence desired by the user.

FIG. 2 illustrates the system implemented on a stand-alone single user system 10 including a computer outfitted with memory adequate to store the system program and the associated graphics files, a CPU, and conventional operating system, such as Microsoft Windows XP®, or other comparable operating system.

The embodiment shown in FIG. 2, utilizes an Intel® Dual-Core Atom 1.6 GHz CPU as the processor, with 4 Gigabytes of random access memory (“RAM”), a 250 GB 7200 rpm removable hard disc drive (“HDD”) with pre-loaded drive image for storing the system program and image files. The system also includes a high definition monitor 22, such as an active matrix LCD/TFT touchscreen w/3 mm safety glass. The system may also optionally include various other user input devices such as a keyboard 24, mouse 26, or joystick (not shown). It will be appreciated that the kiosk 14 illustrated in FIG. 1 may itself include a stand-alone computer. The display utilized in the kiosk 14 is typically a 24 inch diagonal or 37 inch diagonal high definition (such as a 1920×1200 pixel resolution) monitor. Alternatively, a larger (such as a 42 inch diagonal) high definition monitor, either wall-mounted, or table-top mounted, may be employed as the display 22 in the system. The system may include other components, such as an integrated graphics card, internal stereo speakers, integrated sound card, GB Ethernet NIC Network connectivity (10/100/1000baset), and one or more integrated “USB” ports with security shields. The disclosed embodiment employs a Windows 7 Professional® 64-bit Operating System.

The system 10 may also include memory adequate to store and run a separate computer-aided design (“CAD”) program of the type that are currently commercially available and utilized by contractors, designers, and retailers to assist customers in room design and layout, so that the system can be utilized by the customer and dealer to generate a CAD layout of, for example, a kitchen, while at the same time providing the customer with the product choice and visualization provided by the disclosed system 10.

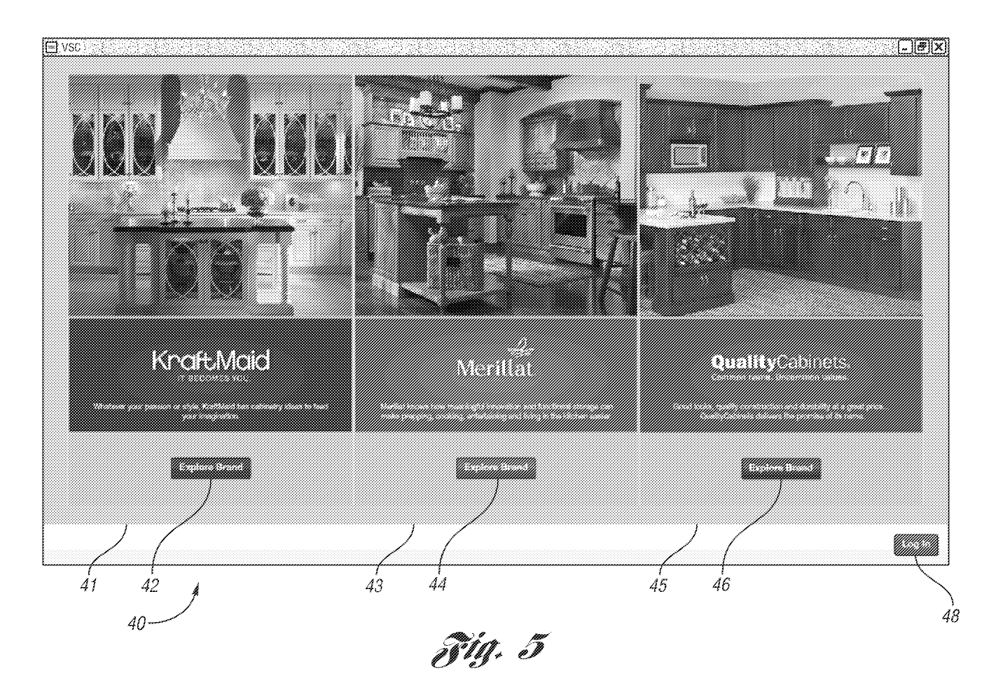

It will be appreciated that the disclosed system and method may employ one or more user stations (shown as 34 in FIG. 2), including one or more kiosks 14. It will be appreciated that employing multiple kiosks allows multiple users to utilize the disclosed system and method simultaneously and/or at multiple locations. It will similarly be appreciated that the disclosed system may employ a single computer (as shown in FIG. 2), or multiple computers (shown as 21, 25 in FIG. 3) connected via a local area network (LAN), a wide area network (WAN), a private intranet, or as depicted in FIG. 3, the Internet 28. Again, the user interface may include a keyboard, mouse, joystick, or other suitable controls in lieu of, or in addition to, the touchscreen employed in the kiosk style user interface depicted in FIG. 1.

One of the computers is suitably programmed to provide a user interface that is employed interactively by one or more users to review brand and model (or “series”) information, as well as product specifications, design and finish combinations for a preselected set of products, and to visualize certain of the products, both in isolation and placed in a full color photorealistic depiction of the selected products in one of a selected number of different room layouts. One or more of the computers is also suitably programmed to access product data, including specifications, written descriptions, demonstrative videos, and simple and/or enhanced images of the products, and/or selected components and/or features of those products. For example, one embodiment includes the above-described data for several different brands of kitchen cabinets, countertops, kitchen appliances, and floors.

In one embodiment, the disclosed system provides the system administrator (such as, for example, the manufacturer of the displayed products), with the ability to activate or de-activate which brands are accessible and displayed in the system. Thus, for example, a manufacturer of multiple brands may selectively activate certain brands at certain dealer locations, and activate certain other brands at other dealer locations where, for example, different dealers carry different brands and/or product series from the manufacturer.

One or more of the computers is also suitably programmed to provide three-dimensional renderings of one or more of a preselected number of kitchen layouts whenever one such layout is selected by the user for visualization. In addition to the three-dimensional rendering, special photorealistic color renderings of each of the product designs, features, textures and colors are provided and stored so that the system may retrieve the appropriate photorealistic renderings corresponding to the set of products/designs/features/colors selected for visualization in the selected room layout. It will be appreciated that the data, including the image rendering data, may be stored in memory on one or more computers, either at the location of the user kiosk (in the case of a single location implementation of system), or remotely of the user kiosks (such as, for example, at computer 25, in the multi-station Internet system shown in FIG. 3).

In one embodiment, the basic architecture of the system consists of a central web administration server and multiple user kiosks. The administration website is built in ASP.NET and allows users to configure brand and product data, dealers (and their associated kiosks and product offerings) and shared user management functions. The kiosk software is built in Adobe AIR technology and communicates with the central web server via a local proxy service to maintain a local cache of product data, imagery, and video assets, and to facilitate shared user management.

Following is a description of the process by which the virtual content corresponding to the photorealistic, visualize-in-room rendering is created for the disclosed system. A single kitchen layout is used as the basis for the following explanation. However, it will be appreciated that the process may be repeated/multiplied for each of the number of kitchen layouts offered to the user. The process begins by creating, two-dimensional digital renditions of the room design (such as floor plans, wall elevations, profiles and cabinet placement), and three-dimensional digital renditions of each product offered (such as cabinets, appliances, and hardware), color/material offerings relating to each product (in the form of physical samples and/or digital representations) for all surfaces (cabinets, walls, floors, backsplash, stains, glazes), and other interior design direction for accessorizing/merchandizing the kitchen. This information is utilized to build high detail three-dimensional digital representations of the kitchen, hardware, accessories, appliances, fixtures, etc. At the same time as the kitchen is being “3D modeled”, all color/materials are being created into seamless textures for all surfaces within the kitchen.

Once the kitchen is modeled as described above, every surface is assigned “rules” pertaining to direction, scale, reflectivity and lighting of the color/material that is about to be applied to a surface. All colors and materials are then applied to the kitchen. Lighting effects are then applied to the kitchen, as well as a camera location that represents the desired view angle for the rendering of the kitchen.

The lighting and camera lens are reviewed and modified to achieve the desired look. The entire 3D environment is then submitted to a rendering farm of multiple computers that create each major surface in an individual graphic or layer. Each of these layers are then verified against the supplied actual color/material samples to ensure accuracy. For the Cabinetry layers there may be an additional production step required to manually digitally apply the glazing and burnished/vintage effects directly to the graphic layer. Upon completion of all graphic layers, each image is uploaded via a conventional file transfer protocol for use in reassembling the layers along with the kitchen layouts into the desired “visualize-in-kitchen” imagery. The above-described rendering programming and data may be developed by known computer programming services providers in the industry.

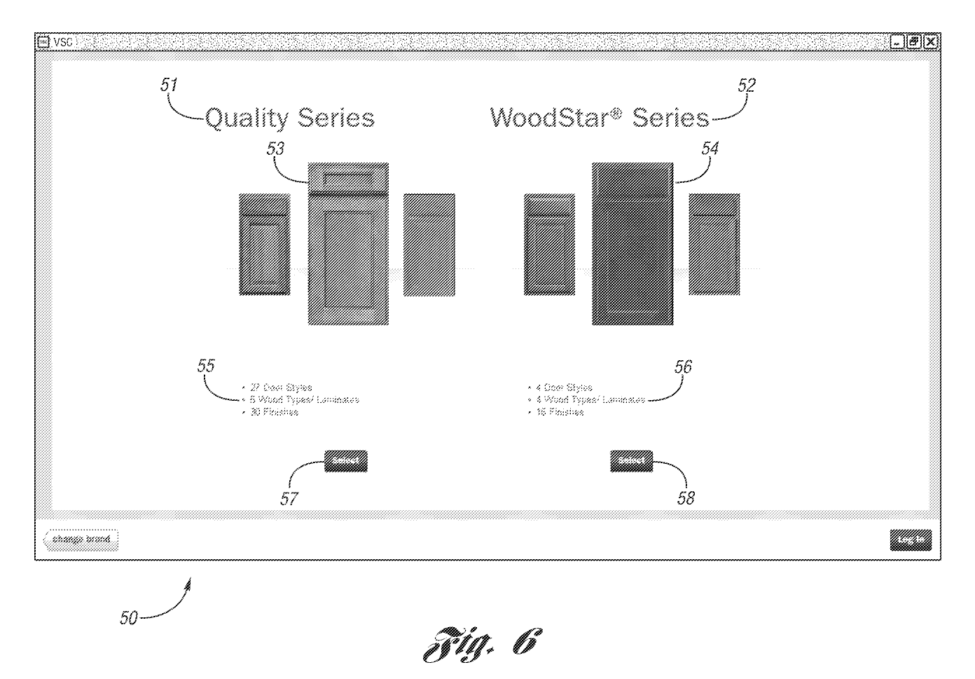

FIG. 4 is a flow chart illustrating an exemplary interaction a user might have with the disclosed system and method. When the user arrives at the kiosk, at 31, he/she will typically view an introductory screen, such as the explore brands screen, which identifies selected brands and/or products for review and consideration. In some installations the system 10 will be installed at a contractors and/or home building products retail outlet along with an actual mock-up of a portion of the room (such as, for example, a kitchen), which includes samples of the selected products installed for visual and tactual inspection. From the kiosk 14, the user may activate various buttons displayed on the screen as described hereinafter to explore product brands, product series, and individual products at various levels of detail, to learn about product features, designs, textures, and colors, as well as combinations with other selected products. Referring again to the flow chart of FIG. 4, a user may typically enter the explore series screen, at 33, to review information relating to a number of selected product lines offered under a particular brand. The user may, for example, access detailed product series messages, videos, and depictions, at 34, and return to the explore series screen or proceed directly to browse individual products. In the illustrated example, the user enters the browse products screen at 35, where he/she is introduced to various product categories, such as, for example, kitchen cabinets, countertops, and flooring. Of course, other products may be included in the system as desired, such as, for example, wall treatments, window treatments, light fixtures, and appliances.

The user will then typically browse various products, such as by moving between the browse product screens and each of the individual product screens, at 36, 37, and 38, to view the products offered, and to select from those products specific items that may be of particular interest to the user. In the process of browsing the user may also switch back and forth between the products screens and various subscreens such as cabinet features, cabinet accessories, and cabinet hardware. Other product specific screens relating to flooring products, countertop products, or other selected products may also be included in the system to provide additional information in the form of text, drawings, photos, and videos regarding particular styles, features, colors, textures, and finishes for the various products.

At any time, and often in multiple iterations, the user may switch from the browse product screen (as shown at 39), or from other of the various product screens to the visualize in room screen, where the user can view selected products integrated into a photorealistic color image of a selected room layout. It will be appreciated that, once viewed, the user may switch from the visual in room screen to other product screens to replace selected products with other products, styles, colors, or features, and return to visualize the newly selected combination of products in the selected room. Similarly, the user may switch from one to another of any of a number of different room layouts, as may be provided in the system, in order to view selected products in a realistic depiction in different room layouts under different lighting and orientations. This free-flowing interactive session typically includes the user accessing the “save selections” screen and/or the email selection screen to save information that has been selected for future sessions, and/or forward that information by email for future reference by the user.

It will be appreciated that the disclosed system and method allows the user to quickly explore myriad combinations of products, designs, colors, finishes, and associated accessories in a high-quality realistic depiction of an exemplary room setting.

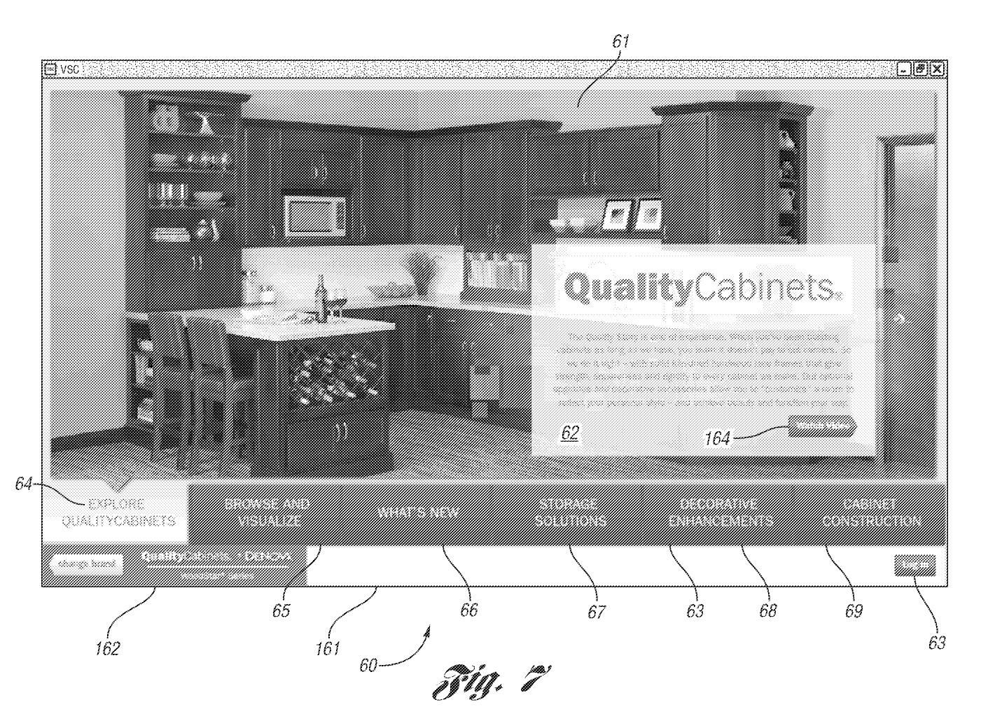

FIG. 5 depicts the “brand” screen 40 employed as the startup screen in one embodiment of the disclosed system. Each of these series of selected brands is depicted in a side-by-side columnar format, with each brand sub window 41, 43, 45 including a photorealistic depiction of the products in a model room setting, a display of the brand name and/or trademark, a brand message and/or product tagline, and an “explore brand” touch-sensitive buttons 42, 44, 46, each of which provides the user an opportunity, upon activation of the button, to receive and review further information about the selected brand, including textual, audio, and video messages. In the depicted embodiment, three brands of kitchen cabinets are supported. The brand screen 40, as well as many of the other system screens, may also include a “Log in” button 48 which allows the user to set up a unique user identification file to provide contact information for the user, as well as memory for storage of selected product information obtained during one or more interactive uses of the system.

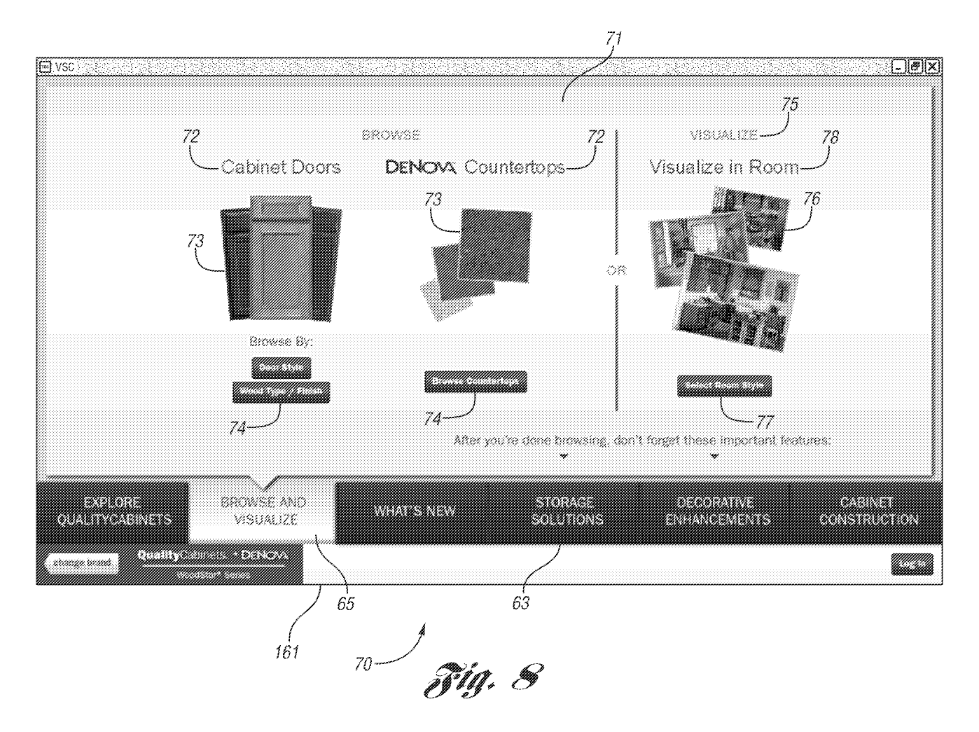

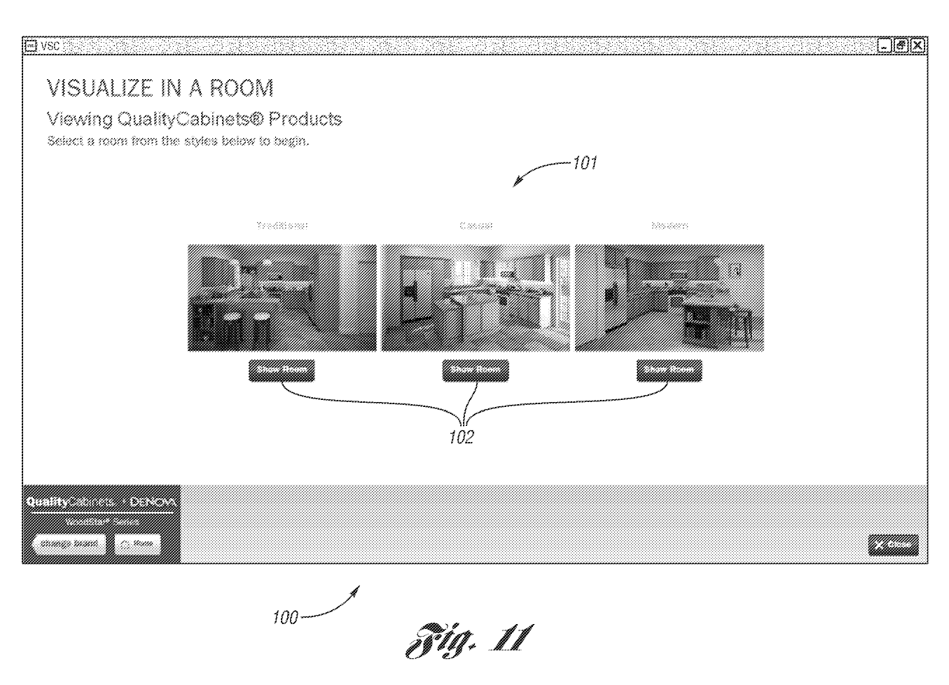

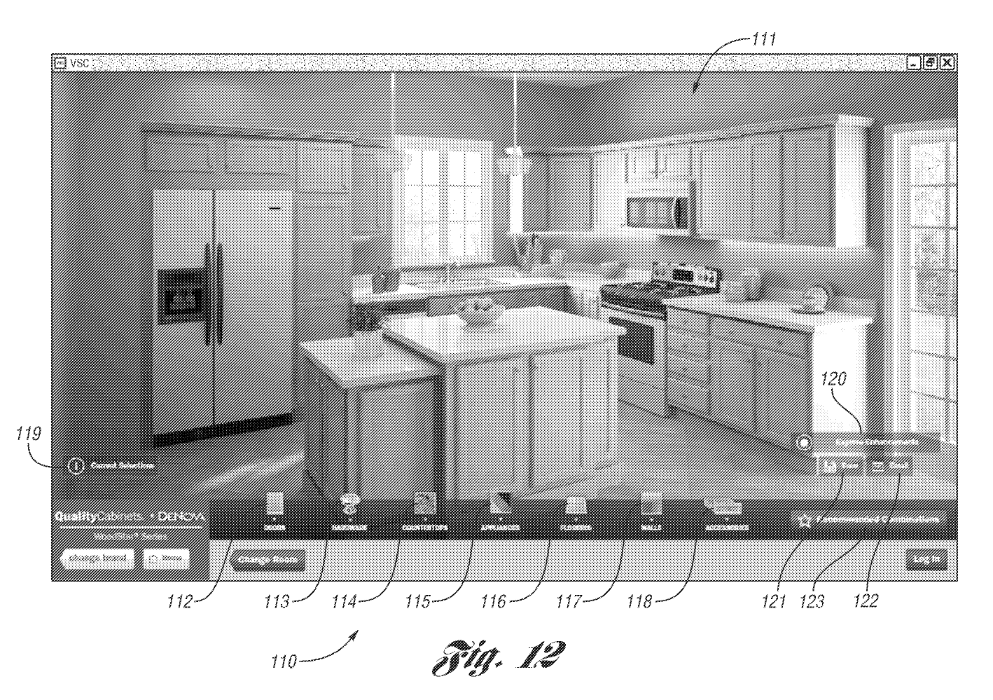

FIG. 6 depicts the “series” screen 50 which may be employed for those brands of products that have multiple series or product lines. In the depicted example, series screen 50 is accessed from a screen activated by the user while exploring the “Kraft Maid” cabinet brand. A pre-defined subset or all of the series or product lines of Kraft Maid brand cabinets are depicted side-by-side on series screen 50. The product series depictions typically include the series name (e.g., “Quality Series” 51 and “WoodStar Series” 52), depictions 53, 54 of one or more products in the series, and selected information messages 55, 56 relating to each series. In the example illustrated in FIG. 5, photographs or photorealistic images of the door styles associated with each cabinet series are included in depictions 53, 54. Alternatively, depictions 53 and 54 may be implemented as “scroll-and-select” windows which allow the user to scroll between the various door styles offered for the associated product series. In the disclosed system, scrolling is accomplished by horizontally “wiping” the touchscreen over the depicted door styles, causing the door styles to rotate from a background position alongside the center featured tour style, to the center foreground position, but it may be alternatively implemented using a horizontal scrollbar or any other of several well-known scrolling regimes employed in computer graphic display systems. In one embodiment of the disclosed system, the user may, by touching the centered door style, select that particular style to either obtain further information about that style, or to incorporate that particular style into the room visualization screen as hereinafter described in connection with reference to FIGS. 10 and 11.

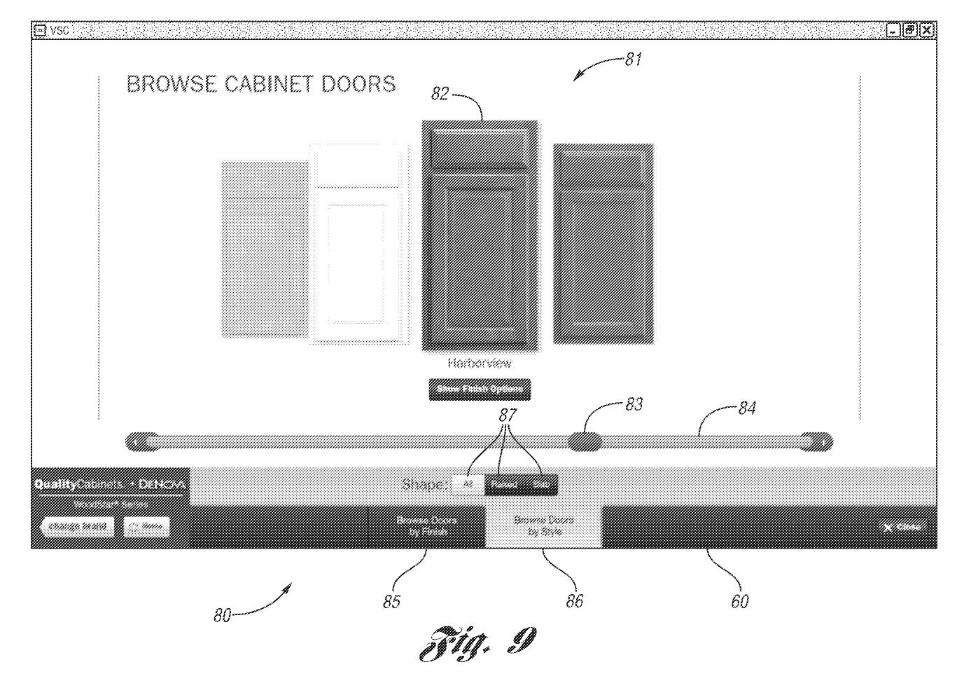

FIG. 7 illustrates the “explore brand” screen 60 which may be employed by the disclosed system and method to allow the user to obtain visual information, such as, for example, in the form of pictures and/or videos, and/or textual information about the selected brand. In the illustrated embodiment, the user has accessed the “Quality Cabinets” explore brand screen by clicking on the “explore brand” button (shown in FIG. 4) to obtain additional information about the Quality Cabinets brand of products. The explore brand screen typically includes a full-with high-quality image 61 of an exemplary style or series of the depicted product brand, a brand message 62, typically displayed as an inset window superimposed on the image 61, and a horizontal button bar 63 including a series of screen activation buttons which allow the user to selectively access additional screens in the system.

For example, in the system depicted in FIG. 7 button bar 63 includes an “explore Quality Cabinets” button 64 (which has been activated to open the depicted screen 61), a “browse and visualize” button 65, a “what's new” button 66, a “storage solutions” button 67, a “decorative enhancements” button 68, and a “cabinet construction” button 69. It should be noted that the horizontal button bar 63 may be used on any or all of the system screens to allow the user to quickly navigate between screens. And, while many of the buttons on the button bar 63 may be desired to be identical from screen-to-screen, it may be desirable to have various other buttons on the button bar 63 of certain screens.

It will be appreciated by those skilled in the art that the use of the button bar 63 in the manner the picked it in FIG. 7 provides an easy identification of optional information screens to the user with minimal obscuration of the image 61 or other primary information depicted on the currently active screen. Thus, the user is provided with a full-width, panoramic image of a particular product/brand while at the same time provided with simple, prominent controls to access other information screens within the system as and when desired.

A relatively less prominent secondary button bar 161 may also be provided to include screen access to, for example, the brand screen (via the “change brand” button 162), the login screen (via the “login” button 163), or other selected screens (via corresponding selection buttons). Also, various other screen activation buttons may be included and employed throughout the screens utilized in the disclosed system to provide the user access to other product/design/type information (such as the “watch video” button 164) via a touch or click by the user.

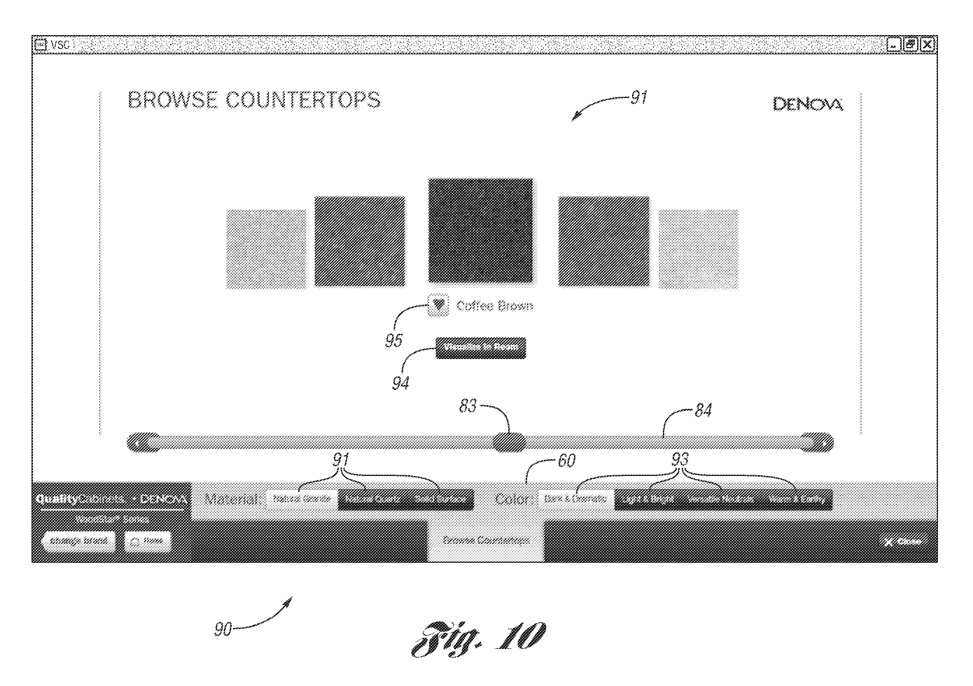

FIG. 8 depicts the “browse and visualize” screen utilized in the disclosed system to depict selected product lines side-by-side, as well as promote access to the “visualize room” screen. In the illustrated example, the browser and visualize screen depicts two featured products, cabinet doors and countertops, under the titled “browse” portion of the screen, as well as a depiction of the visualize opportunity, under the titled “visualize” portion of the screen. The browse and visualize information is depicted in the main display 71, across the full width of the screen, and typically includes a product description 72, images of the product 73, and relatively smaller “browse buttons” 74 which may be activated by the user to browse those particular identified products. The browse buttons 74 may allow the user to browse the product line using different sort criteria (such as style, color, material type, finish, etc.).

The visualize portion 75 of the browse and visualize screen 70 may also include sample depictions of full room visualizations (as shown at 76), as well as a relatively smaller “select room style” button 77 which may be accessed to allow the user to select one from a preselected number of alternative layouts which will be enhanced using all of the various products, styles, colors, textures, and other selectable features selected by the user to form and depict a user-defined photo realistic visualization of the user's selected products in the selected room layout. Again, it will be noted that the use of a horizontal button bar 63, and a secondary button bar 161, provide relatively easy identification of, and quick access to, alternative information screens, while at the same time minimizing the distraction of the user from the visual impact of the information depicted on the main display 71.

FIGS. 9 and 10 illustrate two specific examples of “browse” screens 80, 90. In the “browse cabinet doors” browse screen 80 depicted in FIG. 9, the main browse display 81 typically includes a panoramic view of a subset of the particular product line featured in the selected browse screen (in this example, the WoodStar® Series of QualityCabinets brand cabinets). This panoramic view is typically full screen width, with the center-depicted product 82 appearing highlighted in the foreground of the display. The user can browse through the entire WoodStar Series by touching and sliding the scroll button 83 along the horizontal scrollbar 84 depicted at the bottom edge of the main display 81, to center, highlight, and thereby select one of the particular styles. The horizontal button bar 60 may include one or “sort filter” buttons 85, 86, 87, which allow the user to filter the set of browsed products by certain predefined criteria (such as by product finish, style, and shape, as illustrated in the example of FIG. 9).

In the “browse countertops” screen 90 depicted in FIG. 10, the main browse display 91 includes a panoramic view of a subset of the featured countertop product line (in this example, DeNova brand countertops) in a full screen width view. Again, the user may scroll through the entire set of featured products by touching and sliding the scroll button 83 along the scrollbar 84 on the touch-sensitive display. The horizontal button bar 60 again includes sort filter buttons 91, 93 which allow the user to filter the selected set of products to view only those that satisfy the selected criteria (for example, certain selected material, 91 or color, 93). A “visualize in room” button 94 may be employed beneath the centered, selected one of the browsed set to select that particular item for incorporation in the visualization rendering obtained via the “visualize” screen. A “favorites” button 95, shown depicting a heart icon, is typically located in the product browse displays, such as shown in FIG. 10, to allow the user, upon activation of the button 95, to add the highlighted product design, material, color, etc. to the user's favorites list. It will be appreciated that a favorites button may be similarly placed on other screens to allow the user to quickly update his/her saved list of preferred product/design choices.

Referring now to FIG. 11, the “visualize in room” screen 100 depicts a selected subset or all of the preselected room layouts which may be utilized as the basis for the photorealistic rendering to be generated by the user to include the particular products selected by the user for display in this realistic environment. As with other of these screens described in connection with the disclosed system, the screen may be activated by selection of a “visualize,” “visualize in room,” or other suitably titled button located as desired by the system designer in the other screens. For example, the visualize in room screen 100 may be accessed by touching or clicking on the “visualize in room” text 78 displayed on browse and visualize screen 70 (shown in FIG. 7).

In the illustrated example, the main display 101 includes a full screen width display of each of the three kitchen layout exemplars offered for selection and use by the user in the custom visualization rendering. “Show room” buttons 102 are located beneath each of the depicted room layouts to allow the user to select one of the depicted layouts to view a full screen photorealistic view of the selected room. Once selected, the system displays the “visualize in room” screen.

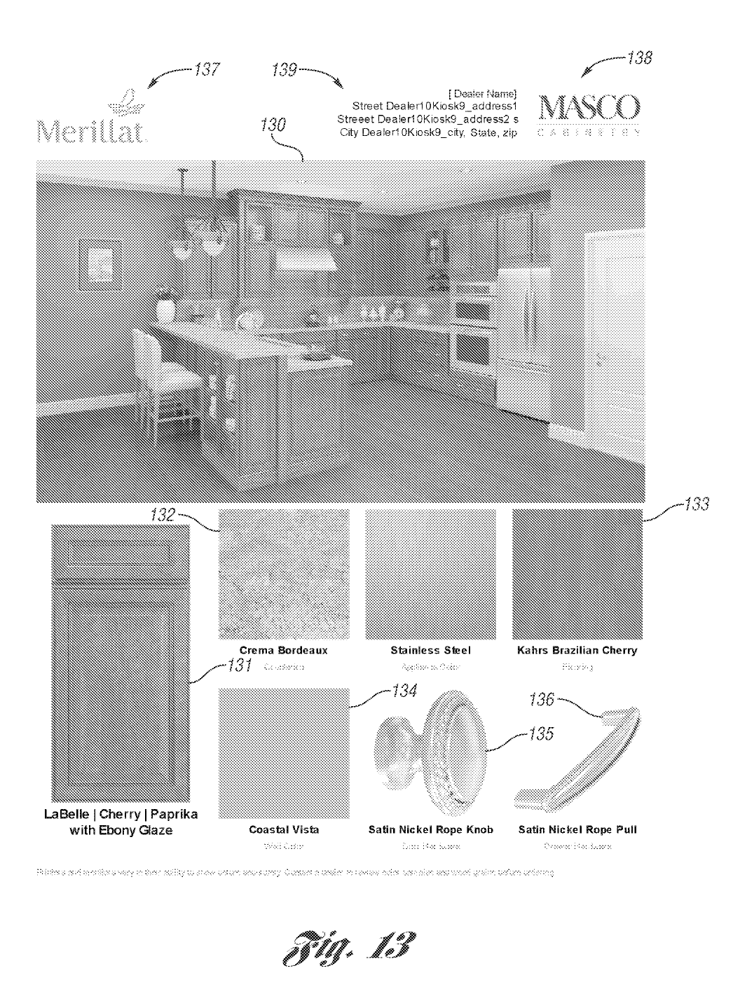

FIG. 12 depicts the “visualize in room” screen 110. In one embodiment, this screen includes a full width main display 111 of a photorealistic color rendering of the selected room layout incorporating all of the products selected by the user for visualization. This three-dimensional rendering displays the particular products, styles, materials, textures, and colors selected for the room by the user in a realistic perspective view that includes a high-definition rendering of the room employing effects that realistically portray natural and artificial lighting, textures and reflections that create a dramatic visual impact for the user, and allow the user a realistic view of specific products installed in a realistic setting. In the disclosed embodiment, this three-dimensional rendering of the selected kitchen with the user's favorite product choices is accomplished by creating and storing a three-dimensional wire-frame image of each of the kitchen layout options. When the user selects “visualize room”, the wire-frame image of the selected layout is digitally “layered” with pre-generated images of each of the selected products in the selected finish, color, and/or texture. Each of these image layers corresponds to a particular product (e.g., cabinets, countertops, appliances, walls, flooring), having a particular style, finish, and/or color, including three-dimensional, interior, and exterior lighting effects that create a photorealistic image when each of the appropriate layers is integrated with the wire frame image for the chosen room. Thus, in the disclosed embodiment of the system dedicated to kitchen products, unique photorealistic layers are created for each variety of kitchen cabinets, hardware (drawer and cabinet handles), appliances, countertops, walls, and flooring, which may be selected by the user, for combination with the wire-frame images of each of the kitchen layouts offered by the system. By combining the appropriate layers corresponding to the selected favorites with the selected wire-frame, a unique, near photographic rendering of the room including the users product selections is generated whenever the user activates the “visualize in room” command.

Again, a horizontal button bar extends across the lower border of the screen 110 and includes a series of “product choice” buttons which allow the user to toggle between the visualize room screen 110 and various browse screens dedicated to specific products and/or accessories to obtain further information and/or switch from particular products displayed in the visualize screen to alternative choices. In the illustrated embodiment, the product choice buttons each comprise an icon and descriptive text. The product choice buttons in the disclosed “kitchen products” application of the system include “doors,” “hardware,” “countertops,” “appliances,” “flooring,” “walls,” and “accessories” buttons 112-118, each of which may be activated by touch to generate a pop-up screen that allows the user to browse the product, design type, or accessory associated with the button. The user is thus provided with a quick and easy way of switching out from selected products/designs/accessories into alternative choices and quickly returning to the visualize room screen 110 to see the selected room realistically rendered with the new choices. Again, the button bar though extensive (typically extending the full width of the screen) and easy to use, provides only minimal obscuration of the full room rendering displayed in the main display 111.

Referring still to FIG. 12, in the disclosed embodiment, the visualize room screen 110 includes a relatively smaller “current selections” button 119 which may be activated by touch to raise a pop-up screen that lists and/or illustrates all the users currently selected items. Thus, upon visualizing the room with the selected choices, the user may quickly, by activating the current selections button, reference the product selections currently visualized. The disclosed environment may also include an “explore enhancements” button 120 which, when activated, displays a pop-up screen providing additional images, videos and/or textual descriptions of selected products/accessories. “Save” button 121 and/or “email” button 122 may also be provided.

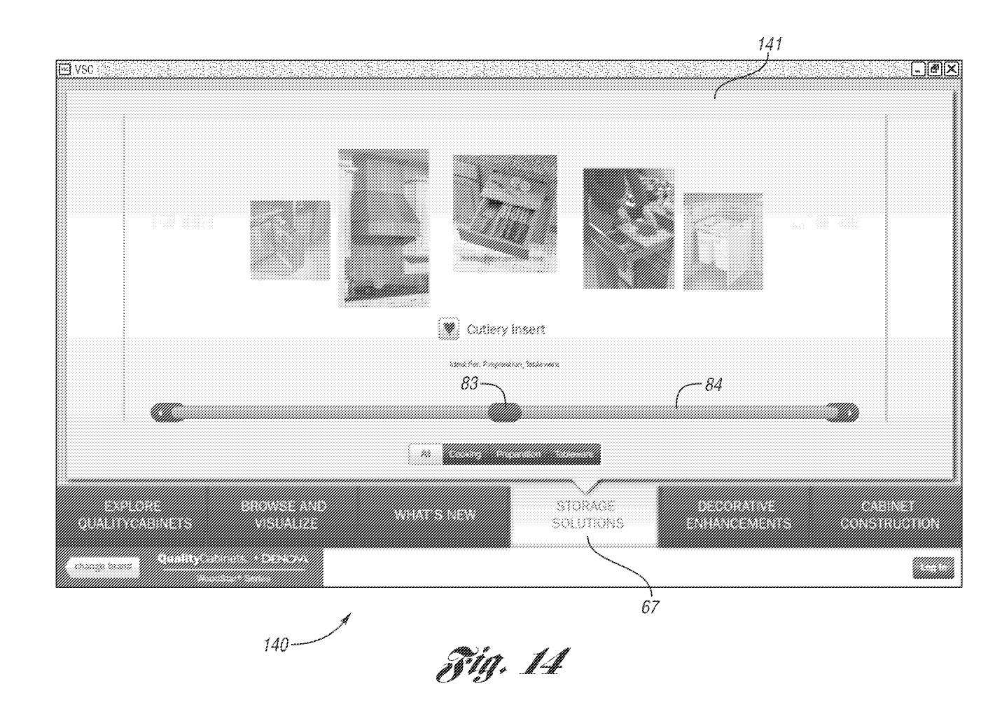

When activated, save button 121 allows the user to save his/her current selections for future reference, provided the user has created an account (through activation of the login button). E-mail button 122 allows the user to e-mail currently selected information to a selected email address. In the disclosed embodiment, upon activation of the email button 122, the system sends a list of the user's current selections (“favorites”) and a “mood board” such as is illustrated in FIG. 13.

The exemplary mood board illustrated in FIG. 13 includes an image of the visualized room 130 depicting the selected room layout with the user's currently selected items, as well as separate graphic and/or textual depictions 131-137 of the user's currently selected items. The mood board also preferably includes a brand descriptor 137 highlighting, for example, one or more of the product lines selected and depicted in the visualized room, a manufacturer descriptor 138 including a logo and/or contact information of one or more of the product manufacturers, and a dealer descriptor 139 including a logo and/or contact information for the retail store at which the user has accessed the system.

If, as in the illustrated embodiment of the disclosed system, the current selections, explore enhancements, and e-mail buttons are positioned within the main display area, they may be generated to displayed or a translucent background to minimize obscuration of the rendered visualization.

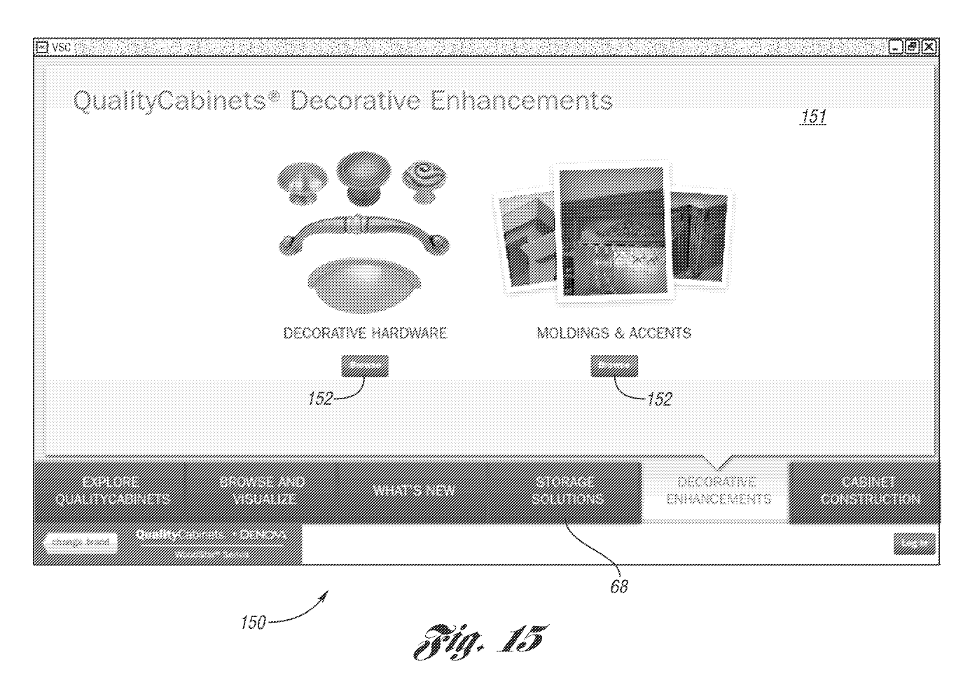

FIG. 14 illustrates a “product features” screen 120 which may be included in the disclosed system. In the disclosed embodiments of this system, this screen is activated by touching the “storage solutions” button 67 that is located on a horizontal button bar 63 in various of the other system screens (as shown in FIGS. 7 and 8). The main display 141 provides a series of image, video, and/or textual messages directed at various product features for selected products (as found, for example, in cabinets), each offering enhanced storage capabilities. The user may scroll between a series of side-by-side depictions of various products/features in the manner previously described to highlight and select additional information for one of the products/features. It will be appreciated that other, similar theme-based screens may also be developed and incorporated in the system to provide focused thematic messages relating to selected products.

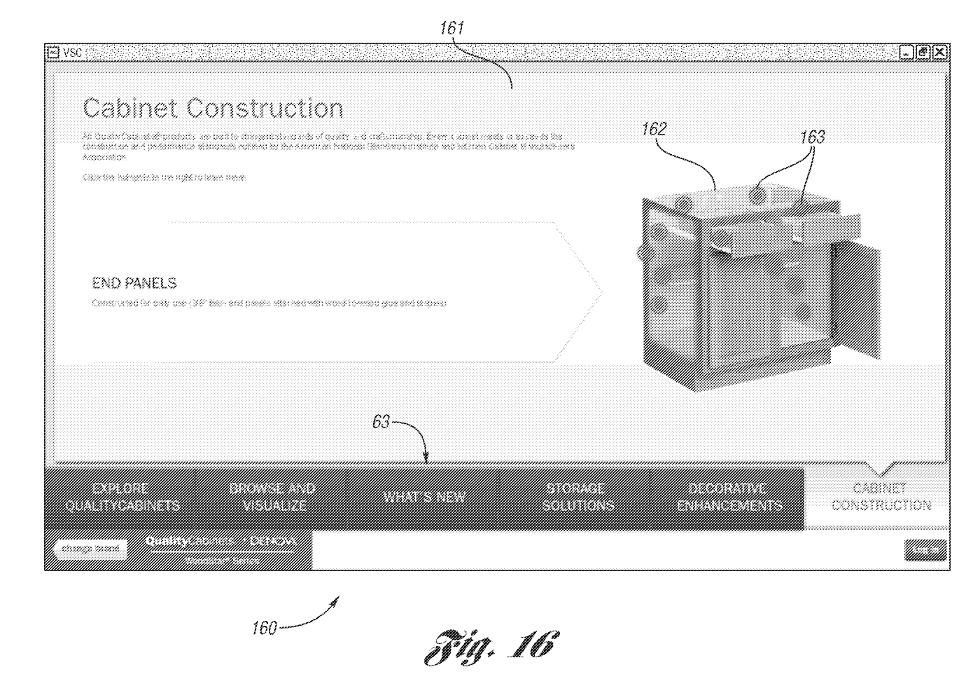

FIG. 15 depicts a “decorative enhancements” screen 150 that may also be included in the disclosed system. In the disclosed embodiment, this screen is also activated by touching the “decorative enhancements” button 68 that is located on a horizontal button bar 63 in various of the other system screens (as shown in FIGS. 7 and 8). The main display 151 provides a series of image, video, and/or textual messages directed at various product enhancement (or accessories) for selected products (as found, for example, in cabinets). The user may choose one of a series of side-by-side depictions of various enhancements/accessories (in the illustrated embodiment, by pressing and associated browse button 152 to obtain additional information for the selected one of the enhancements/accessories.

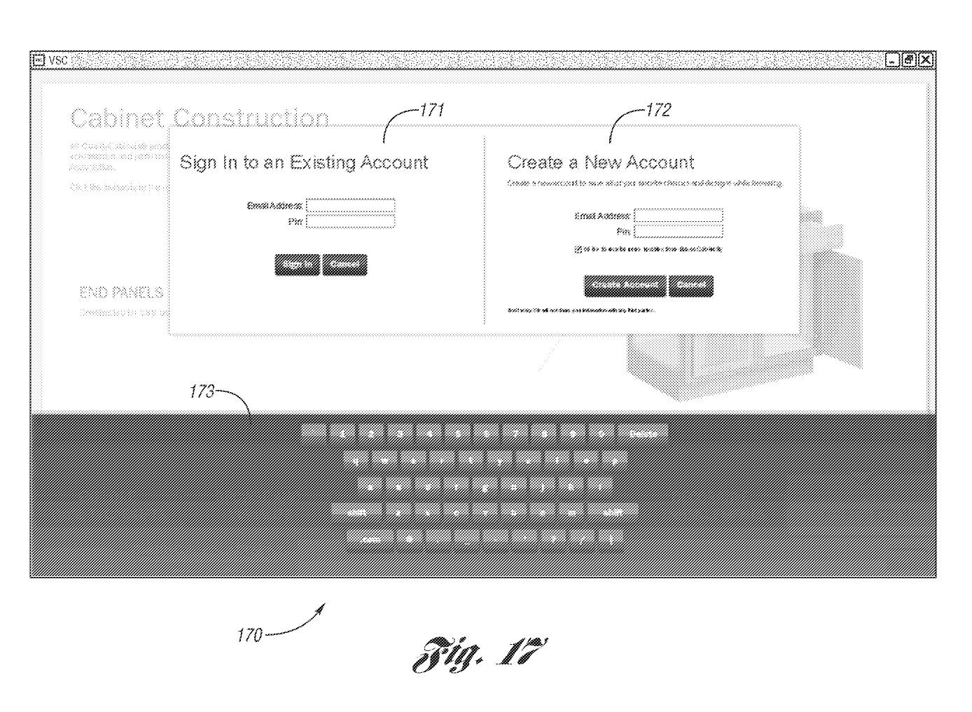

Other product-specific or feature-specific screens may also be implemented to present a particular design theme, or present a graphic display of the utility or quality of a particular design. For example, as illustrated in FIG. 16, a “cabinet construction” screen 160 employs a main display 161 depicting a perspective drawing or photograph or photographic image of a cabinet 162 in partial cross section with preselected “hot spots” 163 identifying construction and/or design features which are desired to be brought to the user's attention. In the disclosed embodiment, the user may touch any of the hot spots 163 to open an additional window and/or text and/or video messages regarding the particular cabinet feature associated with the hot spot 163. The user may thus quickly review one or more of the advantages of the featured product by quickly touching the associated hot spots, after which the user may move to another screen by activating one of the buttons on the horizontal button bar 63.

FIG. 17 illustrates an “account log in” screen 170 which may be implemented in the disclosed system. This screen can be accessed from various other screens by pressing the log in button 48 (shown, for example, in FIG. 4). When opened the screen superimposes an account sign in window 171 and an account creation window 172, either of which may be activated to, respectively, sign in to an existing account or create a new account in the system. For systems implementing a touch sensitive screen, a “querty” keyboard 173 is also displayed to provide the user with a data entry interface. The system provides the user with a unique, password secured account into which data, such as selected products, designs, colors, etc. and communication information, such as the user's email address, may be stored, so that the user can retain desired information obtained through multiple uses of the system, and/or have selected information forwarded by email to the user for use offline from the system.

The disclosed system 10 may include the capability of providing limited access to, and transmitting certain data, such as the customer's contact information (e.g., the user's email address) as well as the “favorite” products selected by that user, to a limited group of users. By “harvesting” user contact and product preference information from some or all of the installations, the manufacturer can get useful contact information as well as customer feedback on preferred product lines, styles, colors, textures, etc. In one embodiment, the disclosed system provides for harvesting user information on a weekly basis. In a networked system such as the type illustrated in FIG. 3, this customer information may be accessed and uploaded on a weekly basis by certain users, such as, for example, the system administrator for the manufacturer. The disclosed system 10 may also provide for similar administrative harvesting of customer information by other selected users, such as personnel at the dealer level, for those customer sites installed at that particular dealer's location.

It will be appreciated that the disclosed system 10 is thus a valuable customer contact and information tool for the manufacturers and/or dealers, as well as a useful product information and visualization tool for the customer.

It will be appreciated that, at any time, the user may access the visualize room screen 111 to obtain a photorealistic rendering of the selected room design including the then-current product/feature selections. Conversely, the system allows the user to access any of the many product/feature browse screens from the visualize room screen, in order to quickly browse and re-select a particular product, design feature, or accessory, and immediately return to the visualize room screen 111 two view the selected room design, now re-rendered to depict the room with the newly modified selections.

In one implementation of the disclosed system, the user kiosk is installed at a retail location, such as at a contractor's retail outlet or building products retail outlet, in proximity to an mock-up of a room including various selected ones of the products featured in the disclosed system. In this environment, the user experiences a combination of exposure to the actual products installed in the mock-up, so the user can see and touch the products to appreciate exemplary styles, materials, and finishes employed in a real room (or portion thereof), while at the same time having immediate and easy access through interactive use of the disclosed system to browse through various products/styles/materials/finishes available as alternatives, and be able to visualize selected alternatives using the “visualize room” rendering provided by the disclosed system.

In one particular embodiment of the disclosed system, a system kiosk is located in proximity to a partial or complete mock-up of a kitchen layout that is identical to one of the featured room layouts that may be selected and visualized by the user of the disclosed system, thereby providing the real-life sensation of similar products actually installed in the mock-up, and simultaneously viewing specific selected items “installed” in a photorealistic rendering of the same room. A “recommended combinations” button 123 may also be provided to, upon activation, display a list of product design combinations recommended by the manufacturer, contractor, or product retailer.

Another alternative embodiment employs the disclosed system as a stand-alone user interface in remote locations where it is not practical to provide real-life mock-ups of the featured products. In this embodiment, the photorealistic “visualize” rendering provided by the disclosed system offers the user the opportunity to receive the visual impact of selected products/designs/materials/textures in a simulated “installed” environment. At the same time, the system provides the user with the opportunity to quickly browse through myriad product choices, and quickly and easily substitute one product design for another to obtain a comparative visualization of the “installed” result.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A home product selection and visualization system for selecting and reviewing furnishings and fixtures for a room, and visualizing certain of the selected furnishings and fixtures in one of a selected room layouts in the form of a photorealistic three-dimensional rendering of the selected room including certain user-selected furnishings or fixtures, the system including:
at least one computer having at least one processor, random access memory, and permanent memory;
at least one user interface including at least one high-definition monitor and at least one data input; and
program logic and image data for creating one or more user-accessible screens when activated by user commands through operation of the user interface, said user-accessible screens including,
at least one brand screen that displays and describes certain pre-selected brands of products and a user-control for selecting one of the described product brands,
at least one browse screen that displays one or more designs for at least one of the products and at least one user-control for selecting at least one of the described product designs, and
a visualize-in-room screen that allows the user to initiate a visualization of a three-dimensional photorealistic rendering of a selected room layout including each of the selected product brands and designs;
program logic for creating and storing in memory a unique user account associated with a user when activated by user commands through operation of the user interface, said unique user account including contact information associated with the user, and certain product, design, color, texture, finish, or associated accessory data selected by the user, and
program logic for retrieving information corresponding to any product, design, color, texture, finish, or associated accessory selected by the user, and transmitting said information to a location remote to the system when activated by the user through operation of the user interface.

2. The home product selection and visualization system of claim 1 wherein the at least one user interface includes at least one stand-alone kiosk, and wherein the at least one data input includes a display having a touch-sensitive screen.

3. The home product selection and visualization system of claim 1 wherein the system includes a plurality of user interfaces, and wherein at least one of the plurality of user interfaces is connected to the at least one computer via the internet.

4. The home product selection and visualization system of claim 1 wherein the program logic includes logic for activating or deactivating which of the preselected brands are accessible and displayed at any one of the at least one user interfaces.

5. A home product selection and visualization system for selecting and reviewing furnishings and fixtures for a room, and visualizing certain of the selected furnishings and fixtures in one of a selected room layouts in the form of a photorealistic three-dimensional rendering of the selected room including certain user-selected furnishings or fixtures, the system including:
at least one computer having at least one processor, random access memory, and permanent memory;
at least one user interface including at least one high-definition monitor and at least one data input; and
program logic and image data for creating user-accessible screens when activated by user commands through operation of the user interface, said user-accessible screens including,
at least one brand screen that displays and describes certain pre-selected brands of products and a user-control for selecting one of the described product brands,
at least one browse screen that displays one or more designs for at least one of the products and at least one user-control for selecting at least one of the described product designs, and
a visualize-in-room screen that allows the user to initiate a visualization of a three-dimensional photorealistic rendering of a selected room layout including each of the selected product brands and designs;
program logic for creating and storing in memory a unique user account associated with a user when activated by user commands through operation of the user interface, said unique user account including contact information associated with the user, and any product, design, color, texture, finish, or associated accessory selected by the user;
program logic and for creating and storing in memory a limited access group; and
program logic for retrieving the contact information corresponding to at least one user, and transmitting said information to a location remote from the system when such retrieval is activated by a member of the limited access group.
